(19) United States
(12) Patent Application Publication
(10) Pub. No.: US 2015/0052307 A1
(43) Pub. Date: Feb. 19, 2015

(54) PROCESSOR AND CONTROL METHOD OF PROCESSOR

(71) Applicant: FUJITSU LIMITED, Kawasaki-shi (JP)

(72) Inventor: TAKAHITO HIRANO, Kawasaki (JP)

(21) Appl. No.: 14/337,311

(22) Filed: Jul. 22, 2014

(30) Foreign Application Priority Data
Aug. 15, 2013 (JP) 2013-168990

(51) Int. Cl. G06F 12/08

(52) U.S. Cl. CPC G06F 12/0875; G06F 2212/452
USPC 711/125

(57) ABSTRACT

When a primary cache controller of a core unit arbitrates and issues a non-cache write request in a thread “0” (zero) and a non-cache read request in a thread 1 from an instruction controller, and when the non-cache requests being arbitration objects are in issuable states by obtaining a response for a preceding non-cache write request after an issuance of the preceding non-cache write request in the thread-0 (zero) which precedes to the non-cache write request in the thread-0 (zero) being the arbitration object, the non-cache read request in the thread-1 is given priority to be issued so that the non-cache read request whose priority is low is not continued to be waited.

### CROSS-REFERENCE TO RELATED APPLICATION

This application is based upon and claims the benefit of priority of the prior Japanese Patent Application No. 2013-168990, filed on Aug. 15, 2013, the entire contents of which are incorporated herein by reference.

### FIELD

The embodiments discussed herein are directed to a processor and a control method of the processor.

### BACKGROUND

There is a CPU (Central Processing Unit) capable of executing an access instruction to a non-cache space being a memory space which is accessed without being intervened by a cache memory. The access instruction to the non-cache space accesses to a device and so on at outside of the CPU without holding an access object data at the cache memory. An access to the non-cache space by a non-cache request is defined as read/write from/to an address space defined as a non-cacheable space. For example, there is an access of a driver of a device performing non-cache write operations and non-cache read operations to verify the write operations as an interrupt process.

The operation relating to the non-cache request is described. At a core unit of the CPU, a primary cache controller receiving the non-cache request issued from an instruction controller checks presence/absence of a non-cache taken response from a secondary cache unit corresponding to a preceding non-cache request just before the non-cache request. The primary cache controller makes an issuance of the succeeding non-cache request wait until the non-cache taken response corresponding to the preceding non-cache request is obtained. The primary cache controller issues the succeeding non-cache request to the secondary cache unit when it is not in a wait state for the non-cache taken response, namely, when the non-cache taken response corresponding to the preceding non-cache request is received.

The secondary cache unit of the CPU issues the non-cache request to a system controller of the CPU when the non-cache request is received from the core unit, and returns the non-cache taken response for the core unit. The system controller issues the received non-cache request toward a device side, and issues a completion notice for a request issuer when a request process at the device side is completed.

[Patent Document 1] Japanese Laid-open Patent Publication No. 2001-117859

There is a case when the instruction controller of the core unit of the CPU issues plural non-cache write requests and plural non-cache read requests. In this case, the primary cache controller issues the preceding non-cache request (non-cache write request or non-cache read request) for the secondary cache unit, and thereafter, makes the issuance of the succeeding non-cache request wait until the non-cache taken response is returned from the secondary cache unit.

When the non-cache taken response from the secondary cache unit corresponding to the preceding non-cache request is returned, the primary cache controller becomes a state in which both the non-cache write request and the non-cache read request are issuable. In general, priority of the non-cache write request is set to be higher than that of the non-cache read request. Accordingly, when the issuances of both the non-cache write request and the non-cache read request are waited, the primary cache controller performs arbitration, and issues the non-cache write request to the secondary cache unit.

For example, at a multi-threading core unit capable of executing two threads of a thread-0 (zero) and a thread-1, the non-cache write request is in the thread-0 (zero), the non-cache read request is in the thread-1, and they are each issued in plural from the instruction controller to the primary cache controller. In this case, according to the arbitration, the non-cache write request in the thread-0 (zero) is continued to be issued, and the non-cache read request in the thread-1 is continued to be waited. For example, in a program in which information written by the non-cache write operation in the thread-0 (zero) is read out by the non-cache read operation in the thread-1 to thereby transit to a next status, it takes a long time until the status transits. As stated above, it is not desirable that a process in a certain thread is delayed and unbalance is generated between threads in throughputs of the instruction at the core unit of the CPU operating in multi-thread.

### SUMMARY

According to an aspect of the embodiment, a processor includes: an instruction control unit which outputs a first non-cache request belonging to a first thread from among plural threads and performing an access without holding an access object data at a cache memory, and a second non-cache request belonging to a second thread from among the plural threads and whose priority is lower than the first non-cache request; and an issuance control unit which issues the non-cache request output from the instruction control unit. The issuance control unit issues the second non-cache request prior to the first non-cache request when the first non-cache request and the second non-cache request output from the instruction control unit are arbitrated to be issued, and when the first non-cache request and the second non-cache request being arbitration objects become in issuable states by obtaining a response for an issued preceding non-cache request after the preceding non-cache request in the first thread preceding to the first non-cache request is issued.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating a configuration example of a processor according to an embodiment of the present invention;

FIG. 2 is a view illustrating an issuance flow of a non-cache request according to the embodiment;

FIG. 3 is a view illustrating a configuration example of a primary cache controller according to the embodiment;

FIG. 4 is a view illustrating a configuration example of a thread arbitration unit (request control unit) according to the embodiment;

FIG. 5 and FIG. 6 are views illustrating configuration examples of a thread arbitration unit (flag generation control unit) according to the embodiment; and

FIG. 7 is a timing chart illustrating an operation example of the processor according to the embodiment.

### DESCRIPTION OF EMBODIMENTS

Hereinafter, preferred embodiments will be explained based on accompanying drawings.

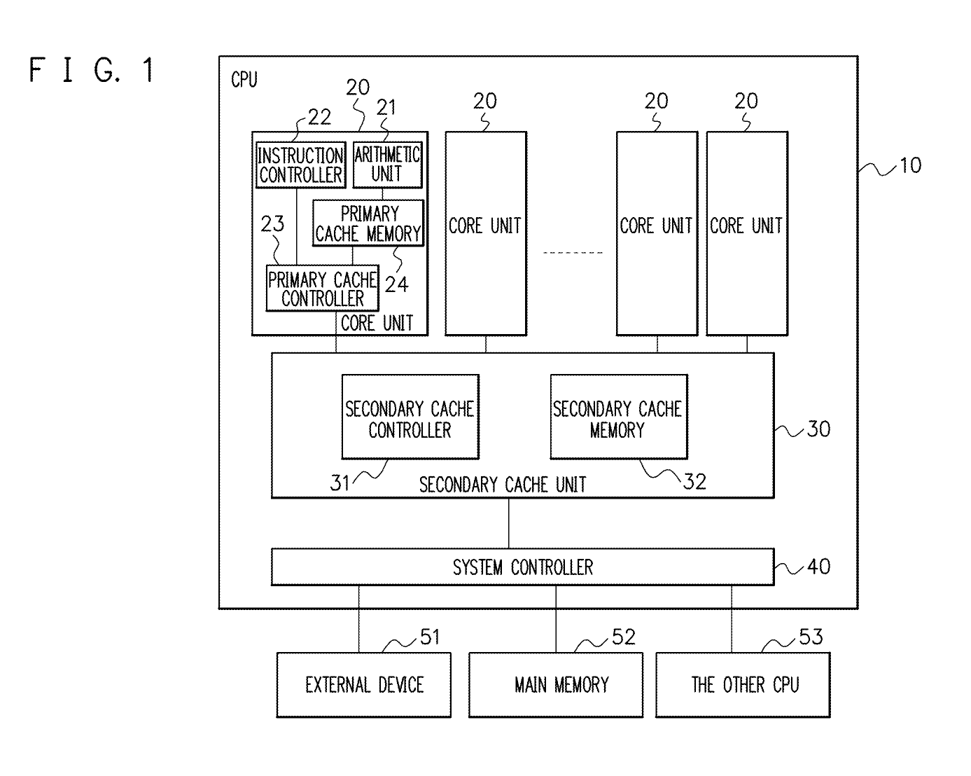

FIG. 1 is a view illustrating a configuration example of a CPU (Central Processing Unit) as a processor according to an embodiment. A CPU 10 includes plural core units 20, a secondary cache unit 30 and a system controller 40.

Each of the core units 20 includes an arithmetic unit 21, an instruction controller 22 decoding an instruction and controlling execution of the instruction, a primary cache controller 23 receiving requests from the instruction controller 22, and a primary cache memory 24 holding data. In the present embodiment, the core unit 20 operates in multi-thread (plural threads), and for example, it is possible to execute two threads of a thread-0 (zero) and a thread-1.

The secondary cache unit 30 includes a secondary cache controller 31 receiving a request for a memory access and a non-cache request performing an access without holding an access object data at a cache memory from the primary cache controller 23 of the core unit 20, and a secondary cache memory 32 holding data. The system controller 40 controls an interface with a device (external device) 51 at outside of the CPU 10, an interface with a main memory 52, an interface with the other CPU 53, and so on.

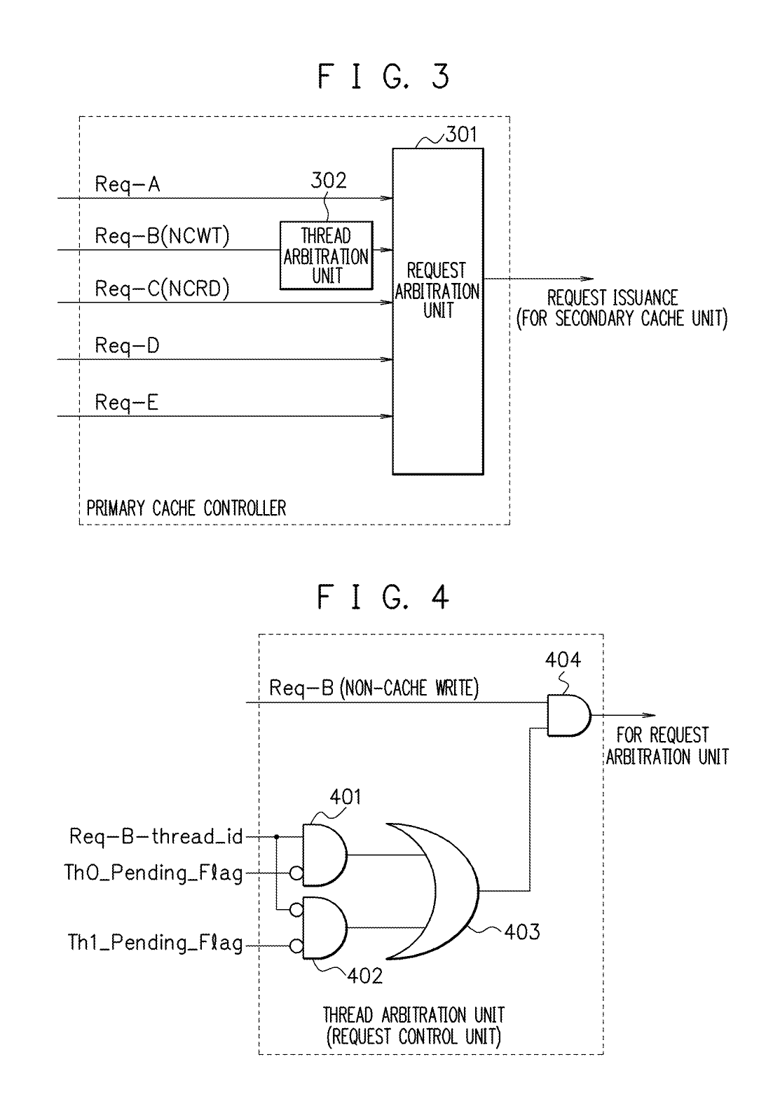

The CPU 10 controls issuances such that a non-cache read request is not continued to be waited when a non-cache write request in one thread and the non-cache read request in the other thread are arbitrated to be issued during an issuance process of the non-cache request by the primary cache controller 23 of the core unit 20. In the present embodiment, as illustrated in FIG. 3, a thread arbitration unit 302 is provided in addition to a request arbitration unit 301 in the primary cache controller 23.

FIG. 3 is a view illustrating a configuration example of the primary cache controller 23 in the present embodiment. The request arbitration unit 301 controls issuances of requests in accordance with priorities set at respective requests. In the present embodiment, the priority of the request issuance of a request Req-A is the highest, the priorities become lower in an order of the requests Req-A, Req-B, Req-C, Req-D, Req-E, and the priority of the request Req-E is the lowest. Besides, the request Req-B is a non-cache write request (NCWT) performing a write access without holding the access object data at the cache memory, and the request Req-C is a non-cache read request (NCRD) performing a read access without holding the access object data at the cache memory. The requests Req-A, Req-D, Req-E are requests different from the non-cache request.

The thread arbitration unit 302 controls issuances of a non-cache write request in a certain thread in accordance with a remaining state of a request in the other thread. When the non-cache write request in the certain thread is issued from the instruction controller 22, the thread arbitration unit 302 refers to a flag indicating the remaining state of the non-cache read request in the other thread. When the non-cache read request in the other thread remains at the request arbitration unit 301, the thread arbitration unit 302 suppresses to send the received non-cache write request to the request arbitration unit 301, and enables the issuance of the non-cache read request in the other thread.

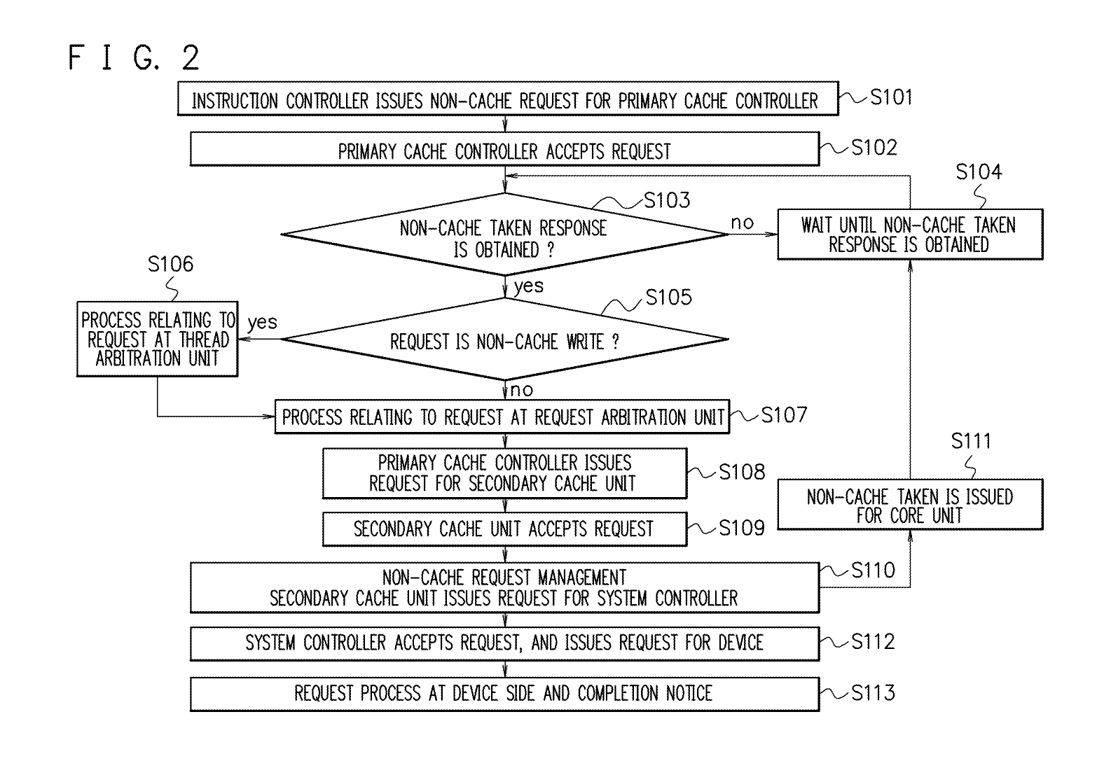

FIG. 2 is a view illustrating an issuance flow of the non-cache request in the present embodiment.

At first, the instruction controller 22 of the core unit 20 issues the non-cache request (non-cache write request or non-cache read request) for the primary cache controller 23 of the core unit 20 (S101).

The primary cache controller 23 accepts the non-cache request from the instruction controller 22 (S102). Subsequently, the primary cache controller 23 checks presence/absence of a non-cache taken response being a response for a preceding non-cache request (S103). When the non-cache taken response corresponding to the preceding non-cache request is not obtained, the primary cache controller 23 makes the non-cache request wait (S104).

When the non-cache taken response corresponding to the preceding non-cache request is obtained, the primary cache controller 23 sends the received non-cache request to the thread arbitration unit 302 when it is the non-cache write request (yes in S105). On the other hand, when the received non-cache request is not the non-cache write request, namely, it is the non-cache read request, the primary cache controller 23 sends the request to the request arbitration unit 301 (no in S105).

The thread arbitration unit 302 includes a flag as pending information indicating that the preceding request is the non-cache write request, and a request whose priority of the request issuance is lower than the non-cache write is in a wait for issuance, by each thread. The thread arbitration unit 302 judges whether or not the received non-cache write request is issuable based on a state of these flags. The thread arbitration unit 302 sends the non-cache write request to the request arbitration unit 301 when it is judged that the received non-cache write request is issuable. On the other hand, the thread arbitration unit 302 suppresses to send the non-cache write request to the request arbitration unit 301 when it is judged that the received non-cache write request is not issuable (S106).

The request arbitration unit 301 issues a request to the secondary cache unit 30 by a priority control arbitrating in accordance with the priority of the request issuance. The primary cache controller 23 of the core unit 20 issues the non-cache request for the secondary cache unit 30 as stated above (S107, S108).

The secondary cache unit 30 accepts the non-cache request from the primary cache controller 23 (S109). Subsequently, the secondary cache unit 30 issues the received non-cache request to the system controller 40 (S110), and returns the non-cache taken response for the core unit (S111). Here, the secondary cache unit 30 manages the number of non-cache requests issuable by the system controller.

The system controller 40 accepts the non-cache request from the secondary cache unit 30, then issues the request toward a device side (S112), and issues a completion notice for an issuer of the request when a process in accordance with the request at the device side is completed (S113).

The tread arbitration unit 302 in the present embodiment is described. The thread arbitration unit 302 includes a request control unit and includes a flag generation control unit by each thread.

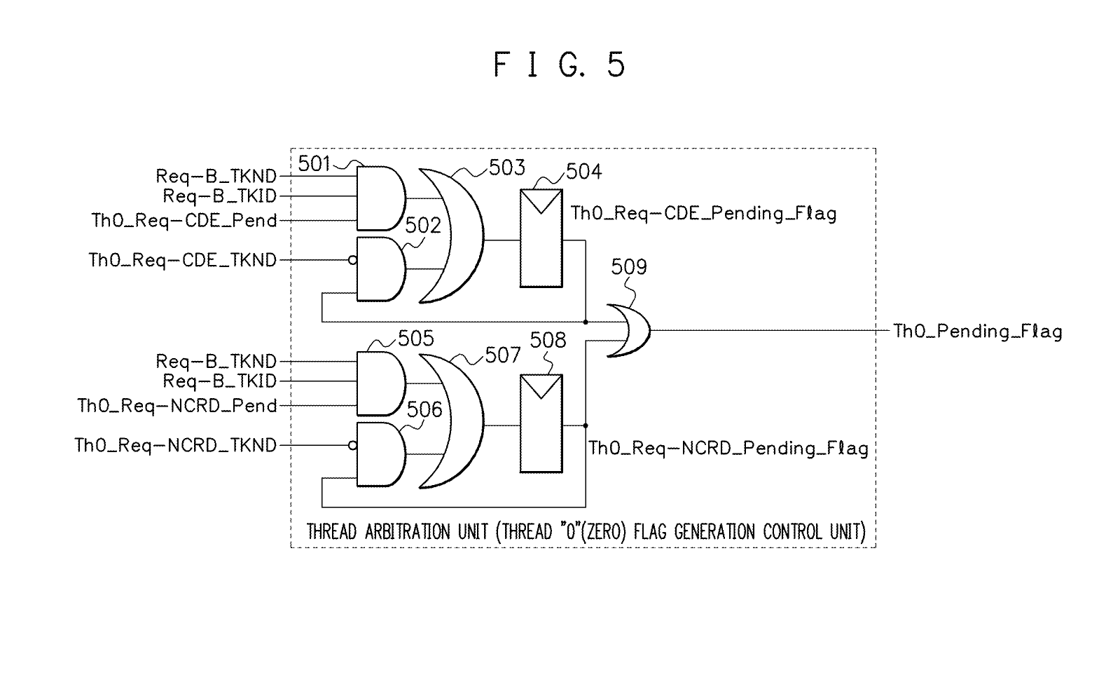

FIG. 4 is a view illustrating a configuration example of the request control unit of the thread arbitration unit 302 according to the present embodiment. The request control unit includes logical product operation circuits (AND circuit) 401, 402 and 404, and a logical sum operation circuit (OR circuit) 403. In the AND circuit 401, a signal Req-B-thread id and a flag Th0_Pending_Flag are input, and a result of a logical product operation of the signal Req-B-thread_id and an inverted flag Th0_Pending_Flag is output. In the AND circuit 402, the signal Req-B-thread_id and a flag Th1_Pending_Flag are input, and a result of a logical product operation of an inverted signal Req-B-thread_id and an inverted flag Th1_Pending_Flag is output.

The signal Req-B-thread_id is a signal indicating a thread which issues the non-cache write request Req-B, and a value is “0” (zero) when the thread-0 (zero) issues the request, and the value is 1 when the thread-1 issues the request. The signal Req-B-thread_id is output from the instruction controller 22 together with the non-cache write request Req-B.

The flag Th0_Pending_Flag is a flag whose value becomes 1 when a request (Req-C, Req-D, Req-E) in the thread-0 (zero) whose priority of the request issuance is lower than the non-cache write request is in the wait for issuance, or a non-cache read request in the thread-0 (zero) is in the wait for issuance. The flag Th1_Pending_Flag is a flag whose value becomes 1 when a request (Req-C, Req-D, Req-E) in the thread-1 whose priority of the request issuance is lower than the non-cache write request is in the wait for issuance, or a non-cache read request in the thread-1 is in the wait for issuance. The flags Th0_Pending_Flag, Th1_Pending_Flag are generated at the flag generation control unit of the thread arbitration unit 302.

In the OR circuit 403, the outputs of the AND circuits 401, 402 are input, and a result of a logical sum operation of these is output. In the AND circuit 404, the non-cache write request Req-B and the output of the OR circuit 403 are input, and a logical product operation of these is performed to be output.

When the value of either of the flags Th0_Pending_Flag, Th1_Pending_Flag of the thread different from the thread issuing the non-cache write request Req-B is 1, the output of the OR circuit 403 becomes “0” (zero), and the request control unit of the thread arbitration unit 302 illustrated in FIG. 4 suppresses the issuance of the non-cache write request Req-B to the request arbitration unit 301. When the value of either of the flags Th0_Pending_Flag, Th1_Pending_Flag of the thread different from the thread issuing the non-cache write request Req-B is “0” (zero), the output of the OR circuit 403 becomes 1, and the request control unit of the thread arbitration unit 302 issues the non-cache write request Req-B to the request arbitration unit 301.

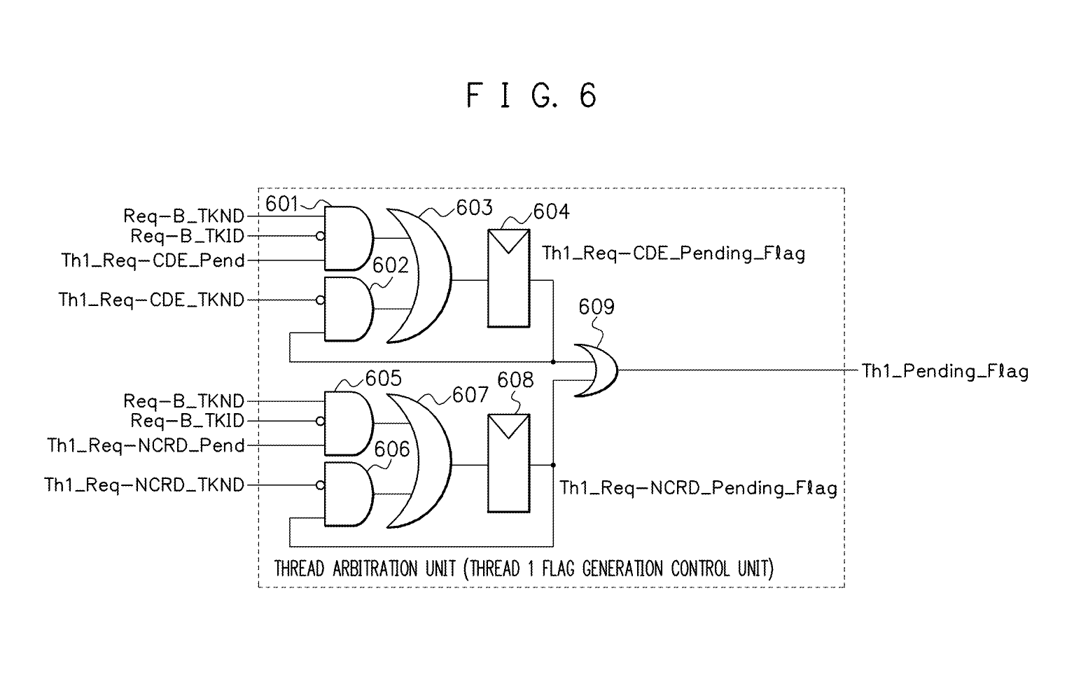

FIG. 5 is a view illustrating a configuration example of a thread-0 (zero) flag generation control unit of the thread arbitration unit 302 according to the present embodiment. The flag generation control unit relating to the thread-0 (zero) includes AND circuits 501, 502, 505 and 506, OR circuits 503, 507 and 509, and latch circuits 504, 508.

In the AND circuit 501, signals Req-B_TKND, Req-B_TKID, Th0_Req-CDE_Pend are input, and a result of a logical product operation of the signals Req-B_TKND, Req-B_TKID, Th0_Req-CDE_Pend is output. In the AND circuit 502, a signal Th0_Req-CDE_TKND and a flag Th0 Req-CDE_Pending_Flag being an output of the latch circuit 504 are input, and a result of a logical product operation of an inverted signal Th0_Req-CDE_TKND and the flag Th0_Req-CDE_Pending_Flag is output. In the OR circuit 503, the outputs of the AND circuits 501, 502 are input, and a result of a logical sum operation of these is output. The latch circuit 504 latches the output of the OR circuit 503, and outputs as the flag Th0_Req-CDE_Pending_Flag.

The signal Req-B_TKND is a signal indicating that the request arbitration unit 301 issues the non-cache write request Req-B for the secondary cache unit 30. The signal Req-B_TKID is a signal indicating the thread which issues the non-cache write request Req-B corresponding to the issued signal Req-B_TKND, and a value is “0” (zero) when it is the thread-0 (zero), and the value is 1 when it is the thread-1. The signal Th0_Req-CDE_Pend is a signal indicating that any of the requests from among the requests Req-C, Req-D, Req-E whose priority of the request issuance is lower than the non-cache write request is in the wait for issuance in the thread-0 (zero).

Owing to the AND circuits 501, 502, the OR circuit 503, and the latch circuit 504, the flag Th0_Req-CDE_Pending_Flag is set (a value becomes 1) if any of the requests from among the requests Req-C, Req-D, Req-E is in the wait for issuance in the thread-0 (zero) when the request arbitration unit 301 issues the non-cache write request Req-B in the thread-1 for the secondary cache unit 30. When any of the requests from among the requests Req-C, Req-D, Req-E in the thread-0 (zero) is issued from the request arbitration unit 301 for the secondary cache unit 30, the flag Th0_Req-CDE_Pending_Flag is released (the value becomes “0” (zero)).

In the AND circuit 505, signals Req-B_TKND, Req-B_TKID, Th0_Req-NCRD_Pend are input, and a result of a logical product operation of the signals Req-B_TKND, Req-B_TKID, Th0_Req-NCRD_Pend is output. In the AND circuit 506, a signal Th0_Req-NCRD_TKND and a flag Th0_Req-NCRD_Pending_Flag being an output of the latch circuit 508 are input, and a result of a logical product operation of an inverted Th0_Req-NCRD_TKND and the flag Th0_Req-NCRD_Pending_Flag is output. In the OR circuit 507, the outputs of the AND circuits 505, 506 are input, an a result of a logical sum operation of these is output. The latch circuit 508 latches the output of the OR circuit 507, and outputs as the flag Th0_Req-NCRD_Pending_Flag. The signal Th0_Req-NCRD_Pend is a signal indicating that the non-cache read request Req-C (NCRD) is in the wait for issuance in the thread-0 (zero).

Owing to the AND circuits 505, 506, the OR circuit 507, and the latch circuit 508, the flag Th0_Req-NCRD_Pending_Flag is set (a value becomes 1) if the non-cache read request is in the wait for issuance in the thread-0 (zero) when the request arbitration unit 301 issues the non-cache write request Req-B in the thread-1 for the secondary cache unit 30. When the non-cache read request in the thread-0 (zero) is issued from the request arbitration unit 301 for the secondary cache unit 30, the flag Th0_Req-NCRD_Pending_Flag is released (the value becomes “0” (zero)).

In the OR circuit 509, the flag Th0_Req-CDE_Pending_Flag and the flag Th0_Req-NCRD_Pending_Flag are input, and a result of a logical sum operation of these is output as the flag Th0_Pending_Flag. Note that the signals Req-B TKND, Req-B_TKID, Th0_Req-CDE_Pend, Th0_Req-CDE_TKND, Th0_Req-NCRD_Pend, Th0_Req-NCRD_TKND are supplied from the request arbitration unit 301.

FIG. 6 is a view illustrating a configuration example of a thread-1 flag generation control unit of the thread arbitration unit 302 in the present embodiment. The flag generation control unit relating to the thread-1 includes AND circuits 601, 602, 605 and 606, OR circuits 603, 607 and 609, and larch circuits 604, 608. In FIG. 6, the same signal names are assigned to the same signals as the signals illustrated in FIG. 5, and redundant description is not given.

In the AND circuit 601, signals Req-B_TKND, Req-B_TKID, Th1_Req-CDE_Pend are input, and a result of a logical product operation of the signals Req-B_TKND, Th1_Req-CDE_Pend, and an inverted signal Req-B_TKID is output. In the AND circuit 602, a signal Th1_Req-CDE_TKND and a flag Th1_Req-CDE_Pending_Flag being an output of the latch circuit 604 are input, and a result of a logical product operation of an inverted signal Th1_Req-CDE_TKND and the flag Th1_Req-CDE_Pending_Flag is output.

In the OR circuit 603, the outputs of the AND circuits 601, 602 are input, and a result of a logical sum operation of these is output. The latch circuit 604 latches the output of the OR circuit 603, and outputs as the flag Th1_Req-CDE_Pending_Flag. The signal Th1_Req-CDE_Pend is a signal indicating that any of the requests from among the requests Req-C, Req-D, Req-E whose priority of the request issuance is lower than the non-cache write request is in the wait for issuance in the thread-1.

Owing to the AND circuits 601, 602, the OR circuit 603, and the latch circuit 604, the flag Th1_Req-CDE_Pending_Flag is set (a value becomes 1) if any of the requests from among the requests Req-C, Req-D, Req-E is in the wait for issuance in the thread-1 when the request arbitration unit 301 issues the non-cache write request Req-B in the thread-0 (zero) for the secondary cache unit 30. When any of the requests from among the requests Req-C, Req-D, Req-E in the thread-1 is issued from the request arbitration unit 301 for the secondary cache unit 30, the flag Th1_Req-CDE_Pending_Flag is released (the value becomes “0” (zero)).

In the AND circuit 605, signals Req-B_TKND, Req-B_TKID, Th1_Req-NCRD_Pend are input, and a result of a logical product operation of the signals Req-B_TKND, Th1_Req-NCRD_Pend, and an inverted signal Req-B_TKID is output. In the AND circuit 606, the signal Th1_Req-NCRD_TKND and a flag Th1_Req-NCRD_Pending_Flag being an output of the latch circuit 608 are input, and a result of a logical product operation of an inverted signal Th1_Req-NCRD_TKND and the flag Th1_Req-NCRD_Pending_Flag is output. In the OR circuit 607, the outputs of the AND circuits 605, 606 are input, and a result of a logical sum operation of these is output. The latch circuit 608 latches the output of the OR circuit 607, and outputs as the flag Th1_Req-NCRD_Pending_Flag. The signal Th1_Req-NCRD_Pend is a signal indicating that the non-cache read request Req-C (NCRD) is in the wait for issuance in the thread-1.

Owing to the AND circuits 605, 606, the OR circuit 607, and the latch circuit 608, the flag Th1_Req-NCRD_Pending_Flag is set (a value becomes 1) if the non-cache read request is in the wait for issuance in the thread-1 when the request arbitration unit 301 issues the non-cache write request Req-B in the thread-0 (zero) for the secondary cache unit 30. When the non-cache read request in the thread-1 is issued from the request arbitration unit 301 for the secondary cache unit 30, the flag Th1 Req-NCRD_Pending_Flag is released (the value becomes “0” (zero)).

In the OR circuit 609, the flag Th1_Req-CDE_Pending_Flag and the flag Th1_Req-NCRD_Pending_Flag are input, and a result of a logical sum operation of these is output as a flag Th1_Pending_Flag. Note that the signals Req-B_TKND, Req-B_TKID, Th1_Req-CDE_Pend, Th1_Req-CDE_TKND, Th1_Req-NCRD_Pend, and Th1_Req-NCRD_TKND are supplied from the request arbitration unit 301.

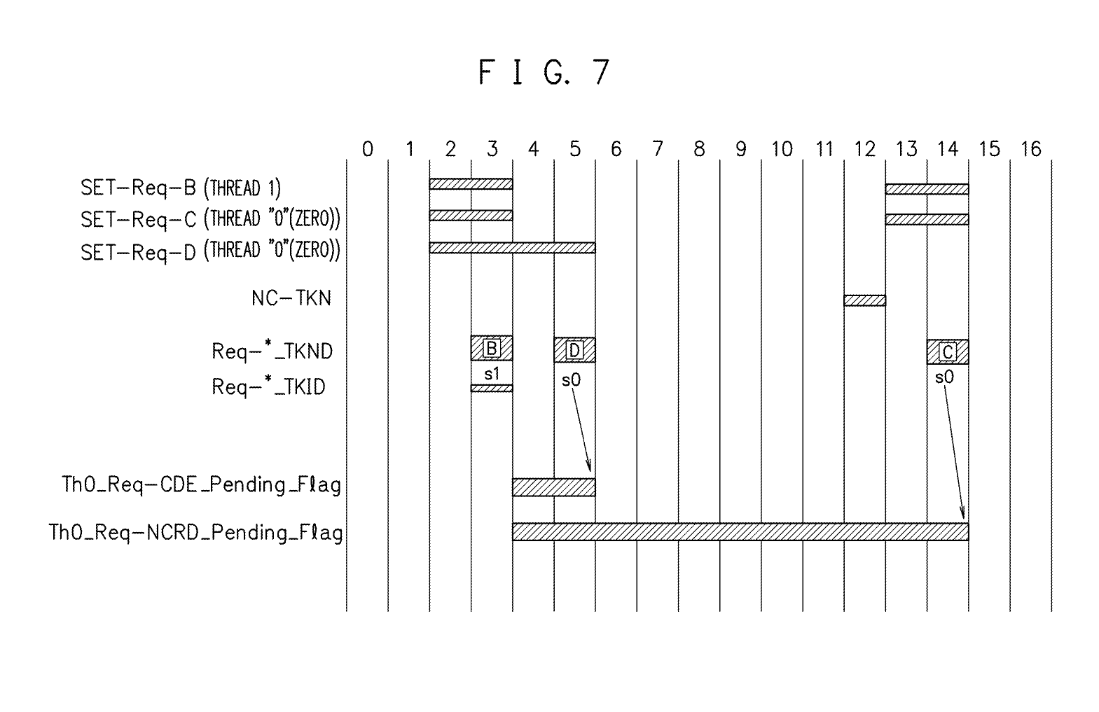

FIG. 7 is a timing chart illustrating an operation example of the processor in the present embodiment. In the example illustrated in FIG. 7, the non-cache write request Req-B is issued in the thread-1, the non-cache read request Req-C is issued in the thread-0 (zero), and the request Req-D is issued in the thread-0 (zero). Besides, there are plural non-cache write requests.

As illustrated in FIG. 7, the non-cache write request Req-B, the non-cache read request Req-C, and the request Req-D are each in states capable of being request issued at the request arbitration unit 301 in a cycle 2. It is not in the wait for the non-cache taken (NC-TKN) response, in addition, the values of the flags Th0_Pending_Flag, Th1_Pending_Flag of the thread arbitration unit 302 are “0” (zero), and therefore, the request arbitration unit 301 of the primary cache controller 23 issues the non-cache write request in the thread-1 (s1) for the secondary cache unit 30. At this time, the requests Req-C, Req-D are in the wait for issuance state in the thread-0 (zero), and therefore, the thread-0 (zero) flag generation control unit of the thread arbitration unit 302 sets the flags Th0_Req-CDE_Pending_Flag, Th0_Req-NCRD_Pending_Flag (sets the values into 1).

The non-cache write request and the non-cache read request are made wait until the non-cache taken response is returned, and therefore, in a cycle 5, the request arbitration unit 301 issues the request Req-D in the thread-0 (zero) (s0) which is not the non-cache request for the secondary cache unit 30. The request Req-D is issued, and thereby, the thread-0 (zero) flag generation control unit of the thread arbitration unit 302 resets the flag Th0_Req-CDE_Pending_Flag (sets the value into “0” (zero)).

After that, in a cycle 12, when the non-cache taken (NC-TKN) response corresponding to the non-cache write request is returned, the request arbitration unit 301 of the primary cache controller 23 is able to issue the non-cache write request and the non-cache read request. Here, the non-cache write request in the thread 1 is suppressed to be issued because the flag Th0_Req-NCRD_Pending_Flag of the thread-0 (zero) is set. Accordingly, the request arbitration unit 301 of the primary cache controller 23 issues the non-cache read request in the thread-0 (zero) for the secondary cache unit 30.

According to the present embodiment, when the non-cache write request in one thread of the thread-0 (zero) and the thread-1 and the non-cache read request in the other thread are arbitrated to be issued, and when the preceding non-cache request is the non-cache write request in one thread, the issuance of the non-cache write request in one thread is suppressed, and the non-cache read request in the other thread is given priority to be issued when a response for the preceding non-cache request is returned and thereby the non-cache request becomes in an issuable state. The non-cache read request is thereby not continued to be waited and it is possible to issue the non-cache request efficiently and properly when the non-cache write request and the non-cache read request in the different threads are arbitrated to be issued. Accordingly, it is possible to improve the issuance efficiency of the non-cache request, and to prevent that unbalance is generated in throughputs of the plural threads.

Note that the example corresponding to the requests in two threads is illustrated in the above-stated embodiment, but the number of threads which are executable by the core unit is not limited thereto. It is possible to expand by providing a flag indicating a wait state (remaining state) of the non-cache read request by each thread even when the number of threads is two or more.

In an aspect of the present invention, when a first non-cache request in a first thread and a second non-cache request in a second thread are arbitrated to be issued, the second non-cache request is not continued to be waited, and it is possible to prevent that unbalance is generated in throughputs of threads.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor, comprising:
an instruction control unit which outputs a first non-cache request belonging to a first thread from among plural threads and performing an access without holding an access object data at a cache memory, and a second non-cache request belonging to a second thread from among the plural threads and whose priority is lower than the first non-cache request; and
an issuance control unit which issues the second non-cache request prior to the first non-cache request when the first non-cache request and the second non-cache request output from the instruction control unit are arbitrated to be issued, and when the first non-cache request and the second non-cache request being arbitration objects are in issuable states by obtaining a response for an issued preceding non-cache request after the preceding non-cache request in the first thread preceding to the first non-cache request is issued.

2. The processor according to claim 1,
wherein the issuance control unit includes:
a holding unit which holds pending information which is set when the second non-cache request is the arbitration object after the preceding non-cache request is issued, and which is released when the second non-cache request being the arbitration object is issued, and
the issuance control unit arbitrates the second non-cache request based on the pending information held at the holding unit.

3. The processor according to claim 2,
wherein the issuance control unit includes:
a request arbitration unit which arbitrates and issues the first non-cache request and the second non-cache request output from the instruction control unit; and
a thread arbitration unit which suppresses an input of the first non-cache request output from the instruction control unit to the request arbitration unit based on the pending information held by the holding unit.

4. The processor according to claim 1,
wherein the first non-cache request is a non-cache write request in which a write access is performed without holding an access object data at the cache memory, and
the second non-cache request is a non-cache read request in which a read access is performed without holding the access object data at the cache memory.

5. A control method of a processor, comprising:
outputting a first non-cache request belonging to a first thread from among plural threads and performing an access without holding an access object data at a cache memory, and a second non-cache request belonging to a second thread from among the plural threads and whose priority is lower than the first non-cache request by an instruction control unit held by the processor; and
issuing the second non-cache request prior to the first non-cache request when the first non-cache request and the second non-cache request output from the instruction control unit are arbitrated to be issued, and when the first non-cache request and the second non-cache request being arbitration objects are in issuable states by obtaining a response for an issued preceding non-cache request after the preceding non-cache request in the first thread preceding to the first non-cache request is issued, by an issuance control unit held by the processor.
